(19) United States
(12) Patent Application Publication
(10) Pub. No.: US 2018/0020793 A1
(43) Pub. Date: Jan. 25, 2018

(54) BAG FOR HOLDING TRAVEL ITEMS, DESIGNED FOR CONVENIENCE

(71) Applicants: BINDU RAMA RAO, LAGUNA NIGUEL, CA (US); MALLIKA RAO JAYANTHI KOLAR, LAGUNA NIGUEL, CA (US)

(72) Inventors: BINDU RAMA RAO, LAGUNA NIGUEL, CA (US); MALLIKA RAO JAYANTHI KOLAR, LAGUNA NIGUEL, CA (US)

(21) Appl. No.: 15/216,696

(22) Filed: Jul. 22, 2016

(51) Int. Cl. A45C 15/00; H02J 7/00; A45C 5/02; A45F 3/04; A45C 13/02; A45C 11/18

(52) U.S. Cl. CPC A45C 15/00; A45C 13/02; A45C 11/182; A45C 5/02; A45F 3/04; H02J 7/0045; H02J 7/0027; A45C 2011/186; A45C 2011/002

(57) ABSTRACT

A bag to be used for travelling, designed for convenience. It holds a traveller's items, including a mobile phone and camera. It helps store the traveller's items safely, conveniently and also helps charge them. It is made of strong material to provide slash resistance, durability and ease of mind during travel.

### CROSS REFERENCES TO RELATED APPLICATIONS

### Background

### 1. Technical Field

The present invention relates generally to bags used to carry items for travel, and specifically to strong bags that can also safely and conveniently store user's clothes and electrical devices.

### 2. Related Art

People have been travelling for ages. Travel for fun or for business has become a common activity. People of late have been carrying mobile phones with them, often taking their mobile phone chargers with them. Similarly, most travellers carry cameras and camcorders with them on their journey, and they pack additional chargers for those cameras and camcorders. When a person travels abroad, that person often takes power adapters with them, and quite often several different power adapters, one for each electrical device, such as the mobile phone, the camera, the hair dryer, etc. These plethora of chargers, cables, power adapters, one for each electrical device packed by the traveller, add to the complexity of packing for a trip, and add to the total luggage weight.

Often, a traveller unpacks all his electrical devices at the end of a day of travel, and back at the hotel, in order to charge them for the next day of use. This involves locating several different power outlets, one for each electrical device to be charged, and then bringing out the charging cables, hooking them up to the electrical devices, and plugging the other end of the charging cables into power adapters (as necessary) before plugging the power adapters into wall sockets. This rigmarole is repeated in reverse order the next day in the morning to repack all those cables, the plurality of power adapters, the wall sockets, and the devices. Often a traveller forgets to repack some of those cables, power adapters and devices, only to realize much later that those items have been left behind at the hotel.

Pickpocketing is a problem in quite a few places where people tend to visit. Pickpockets can be found in several cities and even in rural places all over the world, and losses due to theft are quite devastating to some travellers. For example, a pickpocket may cut open a traveller's bag and steal a purse full of cash and credit cards without the traveller discovering the loss much later. Thieves have been known to slash bags even without the traveller noticing such activities, or realizing that her belongings are being stolen.

There is a need for better bags that are more secure, and more convenient. There is a need for bags that provide the user the ability to easily handle unpacking and repacking at hotels.

Further limitations and disadvantages of conventional and traditional approaches will become apparent to one of ordinary skill in the art through comparison of such systems with the present invention.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a perspective block diagram of a luggage bag for travel items defining a storage volume, wherein the luggage bag comprises a plurality of walls, wherein those of the plurality of walls constituting the outer walls comprise a slash resistant material layer;

FIG. 2 is a perspective block diagram of another bag for travel items; and

FIG. 3 is a perspective block diagram of a multi-pocket travel bag, comprising a first bag region comprising first and second opposing sidewalls, joined together along a first side edge, an opposite second side edge, and a bottom edge, the first second sidewalls being un-joined along at least a portion of their respective top edges to define an opening.

### DETAILED DESCRIPTION OF THE DRAWINGS

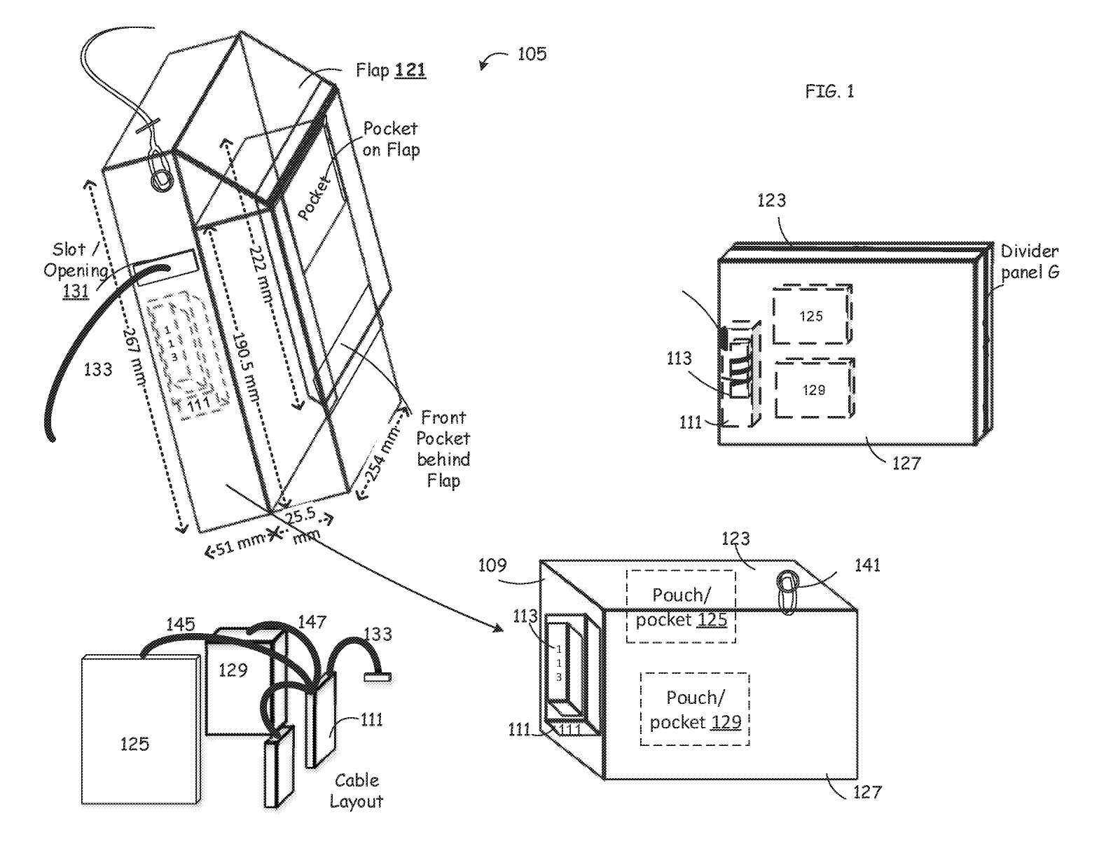

FIG. 1 is a perspective block diagram of a luggage bag for travel items defining a storage volume, wherein the luggage bag 105 comprises a plurality of walls, wherein those of the plurality of walls constituting the outer walls 121 comprise a slash resistant material layer 107. Thus, the items inside the luggage bag 105 is not easy to steal by pickpockets and thieves who often try to silently make a cut or tear in the bag without the traveller/user noticing it. The luggage bag 105 also comprises a first wall 109 among the plurality of walls along which a first holder 111 for a powerbank portable charging device 113 is provided, wherein the powerbank portable charging device 113 supplies power from its built-in batteries through a plurality of USB ports (for example).

The luggage bag 105 also comprises a second wall 123 among the plurality of walls along which a second holder 125 for a mobile device is provided, and a third wall 127 among the plurality of walls wherein a third holder 129 for a camera is provided. The second holder 125 and third holder 129 are in proximity to the first holder 111, in a configuration that minimizes the distance between them. For example, second holder 125 and third holder 129 are each within 2 inches of the first holder 111, in one configuration, making them close enough to connect to their respective devices (that are housed in those holders) to the powerbank portable charging device 113 employing a very short power cable, such as a USB power cable, of about 3 inches or so. The very short power cables are attached to the corresponding walls, in a related embodiment, using glue or stitches.

The luggage bag 105 also comprises a USB outlet 131 on one of the walls constituting the outer walls for a power cable connection to the powerbank portable charging device 113 located in the first holder 111. The USB outlet 131 makes it possible to pass a USB power charging cable 133 out of the bag towards a USB based power outlet, for providing power to the powerbank portable charging device 113.

In one configuration, the luggage bag 105 also comprises a pocket for credit cards 141, to hold a plurality of credit cards. The pocket in a related embodiment comprises a plurality of slots for credit cards, for housing each credit in its own slot inside the pocket.

In a related embodiment, the pocket for credit cards comprises walls with an electromagnetic field (EMF) blocking material layer. In another embodiment, the pocket is large enough to house not only credit cards but also small electronic devices, such as a small mobile phone.

In one configuration, the slash resistant material layer of the luggage bag 105 is secured to corresponding ones of the plurality of outer walls constituting the outer walls, by stitches. In another related configuration, the slash resistant material layer of the luggage bag 105 is secured by glue or staples. Other forms of attaching the slash resistant material layer, such as Kevlar or Nomax aramids for example, are also contemplated.

In one configuration of the luggage bag 105, a first USB power charging cable 145 leading from the first holder 111 to the second holder 125, and a second USB power charging cable 147 leading from the first holder 111 to the third holder 129, are provided. In a related configuration, the first USB power charging cable 145 and the second USB power charging cable 147 are both physically attached to the associated ones of the plurality of outer walls.

In one embodiment, the holders 111, 125, 129 are elastic bands that help secure devices. In another embodiment, the holders 111, 125, 129 are pockets, and in another related embodiment, the holders 111, 125, 129 are pockets with zippers that securely house any electrical or non-electrical devices placed inside.

The luggage bag 105 now makes it possible to
Charge electrical devices on the go, as they are securely housed in pockets in the bag and the powerbank portable charging device provides recharge capabilities even when mobile (in trains, planes, running etc.)
Security and safety provided—Slash resistant bags which pickpockets and thieves will find very hard to slash, cut, etc. to steal items inside
RFID and credit card safe—EMF protection to make sure identity thieves and credit card thieves do not get hold of digital data in credit cards, passports and identity cards
In addition, in some embodiments, the pockets are made of anti-bacterial and anti-microbial material, such that bacteria, mold and fungus does not grow in pockets, even in places where humidity is relatively high.

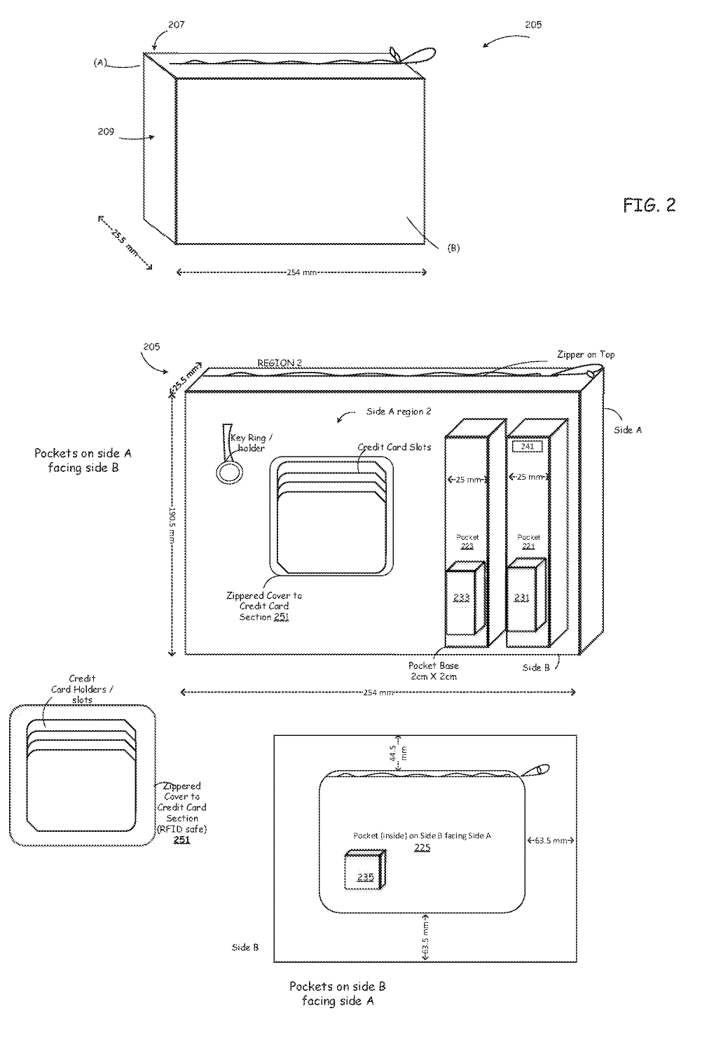

FIG. 2 is a perspective block diagram of another bag 205 for travel items. The bag 205 comprises a body 207 comprising at least one openable and closable surface, wherein the body is surrounding at least one interior compartment 209 with means to gain access to the at least one interior compartment, the at least one interior compartment 209 having sufficient length to house a powerbank portable charging device, a mobile phone, and a camera. FIG. 2 also depicts not only a perspective diagram of the bag 205, but also views for component walls A and B, with exemplary pockets associated on those component walls A & B. Specifically, it shows pockets on Side A of the interior compartment 209, and pockets on side B of the interior compartment 209 facing side A.

The bag 205 comprises at least a first carrying pocket 223 for the mobile phone, a second carrying pocket 225 for the camera and an additional carrying pocket 221 for the powerbank portable charging device. It is important to note that the dimensions shown in the figures for various pockets and various components of the bag are only exemplary and the bag is configured differently (with possibly different dimensions/sizes) for specific embodiments.

The bag 205 simultaneously houses the powerbank portable charging device 231, the mobile phone 233 and the camera 235 in corresponding pockets, while the powerbank portable charging device 231 charges both the mobile phone 233 and the camera 235 simultaneously. The bag 205 provides a charging cable slot 241 through which a first charging cable passes, the powerbank portable charging device 231 is connected to the first charging cable and to an external power outlet employing the first charging cable that travels through the charging cable slot. The bag 205 is configured such that the first charging cable connects the powerbank portable charging device 231 to the external power outlet, so that the bag simultaneously houses the powerbank portable charging device 231, the mobile phone 233 and the camera 235 even as the powerbank portable charging device 231 is charged by the external power outlet and the mobile phone 233 and the camera 235 are at the same time charged by the powerbank portable charging device 231.

In one configuration, the bag 205 is configured to simultaneously house the mobile phone 233 and the camera 235 in corresponding pockets 223, 225, with the powerbank portable charging device 231 electrically connected to an external power outlet, while the powerbank portable charging device 231 charges both the mobile phone 233 and the camera 235 simultaneously. In a related embodiment, additional electrical devices, housed in additional pockets, are also charged by the powerbank portable charging device 231.

The bag 205 comprises a slash resistant fabric covering the body, wherein the slash resistant fabric resists horizontal, vertical and diagonal slashes made from a slashing device. In one related configuration, the slash resistant fabric comprises one or more layers of Kevlar based fabrics. In another configuration, the slash resistant fabric comprises one or more layers of Kevlar fabric strips that are woven into a mat and serves as a strong slash resistant single layer of fabric.

The bag 205 also comprises an electromagnetic field (EMF) 251 blocking pocket configured to hold a plurality of credit cards.

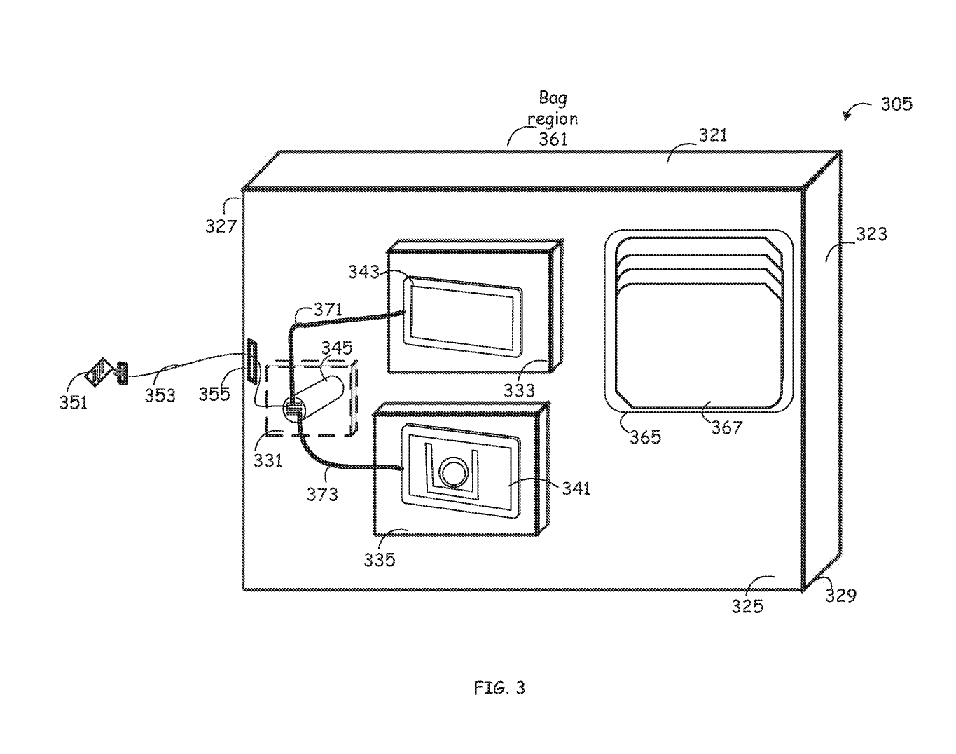

FIG. 3 is a perspective block diagram of a multi-pocket travel bag 305, comprising a first bag region 361 comprising first and second opposing sidewalls 321, 325 joined together along a first side edge 327, an opposite second side edge 323, and a bottom edge 329, the first 321 and second 325 sidewalls being un-joined along at least a portion of their respective top edges to define an opening. The multi-pocket travel bag 305 also comprises a first pocket 331 along the first edge 327 for storing a powerbank charging device 345, and a second pocket 333 along the first sidewall 321 in relative proximity to the first pocket 331, wherein the second pocket 333 is configured to hold a mobile device 343. It also comprises a third pocket 335 along the second sidewall 325 in relative proximity to the first pocket 331, wherein the third pocket 335 is configured to hold one of a camera 341 and a camcorder, and a card holding detachable inner bag 365 positioned within the first bag region 361, the card holding detachable inner bag 365 configured to hold a plurality of credit cards and identity cards, the card holding detachable inner bag comprising a zippered opening section at the top, and walls made with EMF blocking material. The card holding detachable inner bag 365 comprises slots 367 to hold the credit cards and identity cards, one card per slot.

In one configuration, multi-pocket travel bag 305 further comprises slash resistant capabilities—the first 321 and second 325 opposing sidewalls each comprising a layer of slash resistant fabric. In another related configuration, the layer of slash resistant fabric comprises one or more layers of Kevlar-based fabric. In yet another configuration, layer of slash resistant fabric comprises one or more of a Nomax aramid fabric, a nylon based fabric, a denier based fabric, or a combination thereof.

The multi-pocket travel bag 305 comprises, in one configuration, a cable entry slot 355 close to the first pocket 331 and the first edge 327 for passing a cable 353 from an external power outlet 351 or device to the powerbank charging device 345.

The multi-pocket travel bag 305, in another configuration, is configured to simultaneously hold in their respective pockets 331, 333, 335 the powerbank charging device 345, the mobile device 343 and the camera or camcorder 341, even as the powerbank charging device 345 in the first pocket 331 is used to simultaneously charge the mobile device 343 in the second pocket 333 and the camera or camcorder 341 in the third pocket 335.

The multi-pocket travel bag 305, in another configuration, is configured to simultaneously hold in their respective pockets 331, 333, 335 the powerbank charging device 345e, the mobile device 343 and the camera or camcorder 341 even as the powerbank charging device 345 is plugged into a external power outlet 351 or device for charging via a cable 353 passed through the cable entry slot 355, and the mobile device 343 and the camera or camcorder 341 are also at the same time plugged into the powerbank charging device 345 employing appropriate charging cables.

The multi-pocket travel bag 305, in a different configuration, comprises a mobile charging cable 371 positioned along and attached into the first sidewall 321 exposing appropriate sockets at either ends, that enables charging of the mobile device 343 by the powerbank charging device 345. It also comprises a camera or camcorder charging cable 373 positioned along and attached into the second sidewall 325 exposing appropriate sockets at either ends enabling charging of the camera or camcorder 341 by the powerbank charging device 345.

In another configuration of the multi-pocket travel bag 305, the cable entry slot 355 close to the first pocket 331 and the first edge 327 comprises a power charging socket (not shown) to which the powerbank charging device 345 is electrically connected to enable connection to an external power outlet 351 or device employing a power charging cable 353. The power outlet 351 is connected to the power charging socket by means of a charging cable, while the powerbank charging device 345 is electrically connected to the power charging socket inside the bag. In a related configuration, the power charging socket is a USB based socket, to which the powerbank charging device 345 is electrically connected via an appropriate USB cable, to enable connection to an external power outlet 351 or device employing a USB based power charging cable.

In another related embodiment, the multi-pocket travel bag 305 is a backpack, wherein the first sidewall 321 is the front of the backpack, and the second sidewall 325 is the reverse side of the backpack.

As one of ordinary skill in the art will appreciate, the terms “bag” and “travel bag,” as may be used herein, include bags used by a person, to carry during travel a collection of things to wear and personal devices to use, or a collection electrical devices to conduct one's business with.

As one of ordinary skill in the art will appreciate, the terms “connected” and “electrically connected,” as may be used herein, include direct coupling and indirect coupling via another component, element, circuit, or module where, for indirect coupling, the intervening component, element, circuit, or module does not modify the charging function but may adjust its current level, voltage level, and/or power level.

Although the present invention has been described in terms of USB based power charging of devices, other forms and techniques to charge electrical devices such as mobile phones and cameras are also contemplated.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A luggage bag for travel items defining a storage volume:
a plurality of walls, wherein those of the plurality of walls constituting the outer walls comprise a slash resistant material layer;
a first wall among the plurality of walls along which a first holder for a powerbank portable charging device is provided, wherein the powerbank portable charging device supplies power from its built-in batteries through a plurality of USB ports;
a second wall among the plurality of walls along which a second holder for a mobile device is provided;
a third wall among the plurality of walls wherein a third holder for a camera is provided;
wherein the second holder and third holder are in proximity to the first holder, in a configuration that minimizes the distance between the them; and
a USB outlet on one of the walls constituting the outer walls for a power cable connection to the powerbank portable charging device located in the first holder.

2. The luggage bag of claim 1 further comprising:
a pocket comprising a plurality of slots for credit cards, to hold a plurality of credit cards, each in its own slot inside the pocket;
wherein the pocket comprises walls with an electromagnetic field (EMF) blocking material layer.

3. The luggage bag of claim 1 wherein the slash resistant material layer is secured to corresponding ones of the plurality of outer walls constituting the outer walls, by stitches.

4. The luggage bag of claim 1 further comprising:
a first USB power charging cable leading from the first holder to the second holder, and a second USB power charging cable leading from the first holder to the third holder.

5. The luggage bag of claim 4 further comprising:
the first USB power charging cable and the second USB power charging cable both physically attached to the associated ones of the plurality of outer walls.

6. A bag, the bag comprising:
the bag having a body comprising at least one openable and closable surface, wherein the body is surrounding at least one interior compartment with means to gain access to the at least one interior compartment, the at least one interior compartment having sufficient length to house a powerbank portable charging device, a mobile phone, and a camera, the bag having at least a first carrying pocket for the mobile phone, a second carrying pocket for the camera and an additional carrying pocket for the powerbank portable charging device;
the bag simultaneously housing the powerbank portable charging device, the mobile phone and the camera in corresponding pockets, while the powerbank portable charging device charges both the mobile phone and the camera simultaneously.

7. The bag of claim 6 further comprising:
a charging cable slot through which a first charging cable passes, the powerbank portable charging device is connected to the first charging cable and to an external power outlet employing the first charging cable that travels through the charging cable slot; and
wherein the bag is configured such that the first charging cable connects the powerbank portable charging device to the external power outlet, so that the bag simultaneously houses the powerbank portable charging device, the mobile phone and the camera even as the powerbank portable charging device is charged by the external power outlet and the mobile phone and the camera are at the same time charged by the powerbank portable charging device.

8. The bag of claim 6 wherein the bag is configured to simultaneously house the mobile phone and the camera in corresponding pockets, with the powerbank portable charging device electrically connected to an external power outlet, while the powerbank portable charging device charges both the mobile phone and the camera simultaneously.

9. The bag of claim 6 further comprising:
a slash resistant fabric covering the body, wherein the slash resistant fabric resists horizontal, vertical and diagonal slashes made from a slashing device.

10. The bag of claim 9 further comprising:
an electromagnetic field (EMF) blocking pocket configured to hold a plurality of credit cards; and
wherein the slash resistant fabric comprises one or more layers of Kevlar based fabrics.

11. A multi-pocket travel bag, comprising:
a first bag region comprising first and second opposing sidewalls joined together along a first side edge, an opposite second side edge, and a bottom edge, the first and second sidewalls being un-joined along at least a portion of their respective top edges to define an opening;
a first pocket along the first edge for storing a powerbank charging device;
a second pocket along the first sidewall in relative proximity to the first pocket, wherein the second pocket is configured to hold a mobile device;
a third pocket along the second sidewall in relative proximity to the first pocket, wherein the third pocket is configured to hold one of a camera and a camcorder; and
a card holding detachable inner bag positioned within the first bag region, the card holding detachable inner bag configured to hold a plurality of credit cards and identity cards, the card holding detachable inner bag comprising a zippered opening section at the top, and walls made with EMF blocking material.

12. The multi-pocket travel bag of claim 11 further comprising:
the first and second opposing sidewalls each comprising a layer of slash resistant fabric.

13. The multi-pocket travel bag of claim 12 wherein the layer of slash resistant fabric comprises one or more layers of Kevlar-based fabric.

14. The multi-pocket travel bag of claim 11 further comprising:
a cable entry slot close to the first pocket and the first edge for passing a cable from an external power outlet or device to the powerbank charging device.

15. The multi-pocket travel bag of claim 14 wherein the bag is configured to simultaneously hold in their respective pockets the powerbank charging device, the mobile device and the camera or camcorder, even as the powerbank charging device in the first pocket is used to simultaneously charge the mobile device in the second pocket and the camera or camcorder in the third pocket.

16. The multi-pocket travel bag of claim 14 wherein the bag is configured to simultaneously hold in their respective pockets the powerbank charging device, the mobile device and the camera or camcorder even as the powerbank charging device is plugged into a external power outlet or device for charging via a cable passed through the cable entry slot, and the mobile device and the camera or camcorder are also at the same time plugged into the powerbank charging device employing appropriate charging cables.

17. The multi-pocket travel bag of claim 16 further comprising;
a mobile charging cable positioned along and attached into the first sidewall exposing appropriate sockets at either ends enables charging of the mobile device by the powerbank charging device; and
a camera or camcorder charging cable positioned along and attached into the second sidewall exposing appropriate sockets at either ends enables charging of the camera or camcorder by the powerbank charging device.

18. The multi-pocket travel bag of claim 14 further comprising:
the cable entry slot close to the first pocket and the first edge comprises a power charging socket to which the powerbank charging device is electrically connected to enable connection to an external power outlet or device employing a power charging cable.

19. The multi-pocket travel bag of claim 18 wherein the power charging socket is a USB based socket, to which the powerbank charging device is electrically connected via an appropriate USB cable, to enable connection to an external power outlet or device employing a USB based power charging cable.

20. The multi-pocket travel bag of claim 11 wherein the multi-pocket travel bag is a backpack, wherein the first sidewall is the front of the backpack, and the second sidewall is the reverse side of the backpack.
